(19) United States
(12) Patent Application Publication
(10) Pub. No.: US 2009/0085249 A1
(43) Pub. Date: Apr. 2, 2009

(54) FILM STRETCHING METHOD, FILM STRETCHING DEVICE AND SOLUTION CASTING METHOD

(75) Inventor: Toshinao Arai, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/239,702

(22) Filed: Sep. 26, 2008

(30) Foreign Application Priority Data
Sep. 27, 2007 (JP) 2007-250764

(51) Int. Cl. B29C 55/14

(52) U.S. Cl. 264/290.2; 264/298; 425/404

(57) ABSTRACT

In a first zone of a tenter section, damp air is applied to side edge portions of a TAC film, thereby providing the TAC film with a water content profile in which water content decreases from the side edge portions toward a center portion. This water content profile causes the TAC film to have a birefringence profile in which a birefringence decreases from the side edge portions toward the center portion. The TAC film is stretched in a width direction while the side edge portions are being held with clips. Due to a low flexibility at the side edge portions during the stretching process, the birefringence of the TAC film increases such that an increase in the birefringence becomes larger from the side edge portions toward the center portion. A difference of the birefringence in the width direction before the stretching process compensates a difference of the increase in the birefringence in the width direction after the stretching process. The water content of the TAC film is then evaporated.

### FIELD OF THE INVENTION

The present invention relates to a film stretching method, a film stretching device and a solution casting method.

### BACKGROUND OF THE INVENTION

Recently, in accordance with rapid development and popularization of liquid crystal display (LCD) or the like, the demand for a cellulose acylate film, in particular, a triacetyl cellulose (TAC) film used as a protective film for polarizing films or the like, has been increasing. According to the increase in the demand for the TAC film, the improvement in productivity thereof has been desired. The TAC film is produced in the following method. A dope containing the TAC and a solvent is cast through a casting die onto a support continuously moving to form a casting film thereon. The casting film is dried or cooled to have a self-supporting property. A self-supporting casting film is peeled from the support to form a wet film. The wet film is dried and wound as a film. According to a solution casting method described above, it is possible to form a film containing less foreign materials and having more excellent optical properties in comparison with a film forming method by melt-extrusion.

As a method for adjusting the optical properties, especially retardation, of the TAC film, the following method is known. To arrange polymer molecules in a predetermined direction, the TAC film is stretched in a predetermined direction while side edges thereof are held with, for example, clips by using a tenter or the like (see Japanese Patent Laid-open Publication No. 2002-311240, for example).

However, according to the method of stretching the long TAC film in a film width direction while holding the side edges thereof with clips or the like, as disclosed in the Japanese Patent Laid-open Publication No. 2002-311240, the orientation of the polymer molecules occurs unevenly. Specifically, the polymer molecules orientation is more likely to occur at a center portion of the TAC film as compared to the side edge portions and around the side edge portions of the TAC film. That is, the amount of increase in in-plane retardation Re increases from the side edge portions to the center portion. Such TAC film having uneven in-plane retardation Re in the film width direction exerts optical anisotropy, and therefore not preferable as the protective film. It is possible to cut out the portion with even in-plane retardation Re as a product film by cutting off the side edge portions of the TAC film after the stretching. However, the amount of the portions being cut off may increase as the unevenness of the in-plane retardation Re increases, which limits the improvement in productivity.

### SUMMARY OF THE INVENTION

It is an object of the present invention to provide a film stretching method and a film stretching device that provide a film with desired in-plane retardation Re while controlling unevenness of the in-plane retardation Re in a width direction. It is another object of the present invention to provide a solution casting method for effectively producing a film with even in-plane retardation Re in the width direction.

In order to achieve the above objects and other objects, a film stretching method of the present invention includes a water content profile providing step, a stretching step, and an evaporating step. In the water content profile providing step, a film is provided with a water content profile in which water content decreases from side edge portions toward a center portion in a width direction by bringing the film into contact with water. The water content profile causes the film to have a birefringence profile in which a birefringence decreases from the side edge portions toward the center portion in the width direction. In the stretching step, the film having the water content profile and the birefringence profile in the width direction is stretched while the side edge portions are being held. The film being held at its side edge portions has a stretching property that decreases as closer to the side edge portions. The birefringence increases after the stretching step such that an increase in the birefringence becomes larger from the side edge portions toward the center portion. The stretching property causes a difference of the increase in the birefringence in the width direction. A difference of the birefringence in the width direction before the stretching step compensates the difference of the increase in the birefringence in the width direction after the stretching step. In the evaporating step, the water of the film is evaporated after the stretching step.

It is preferable that the water content of each side edge portion is at least 1 wt. % and at most 5 wt. % higher than the water content of the center portion. In addition, it is preferable that the water content of each side edge portion and the water content of the center portion are respectively at least 2 wt. % and at most 10 wt. %.

The water content profile providing step preferably includes the step of applying damp air whose humidity is at least 60%RH and at most 100%RH to the film at a volume gradually decreasing from the side edge portions toward the center portion in the width direction. Moreover, a content of remaining solvent in the film during the stretching step is preferably at least 0.1 wt. % and at most 10 wt. %.

The water content profile providing step preferably includes the steps of bringing a whole film into contact with the water; and evaporating the water of the center portion after bringing the whole film into contact with the water. The film is preferably in a falling-rate drying period while evaporating the water of the center portion.

A temperature of the film during the stretching step is preferably at least 50° C. and at most 150° C.

A solution casting method of the present invention includes a casting step of casting a dope containing a polymer and a solvent on a support continuously moving and forming a casting film on the support, a peeling step of peeling the casting film, turned into gel by cooling, as a film, and the above-described water content profile providing step, the stretching step, and the evaporating step.

A film stretching device of the present invention includes a water content profile providing section, a pair of holding members, a stretching section, and an evaporating section. The water content profile providing section provides the film with a water content profile in which water content decreases from side edge portions toward a center portion in a width direction by bringing the film into contact with water. The water content profile causes the film to have a birefringence profile in which a birefringence decreases from the side edge portions toward the center portion in the width direction. The pair of holding members holds the side edge portions of the film having the water content profile and the birefringence profile. The stretching section stretches the film in the width direction by guiding the holding members. The film being held at its side edge portions has a stretching property that decreases as closer to the side edge portions. The birefringence increases after the stretching step such that an increase in the birefringence becomes larger from the side edge portions toward the center portion. The stretching property causes a difference of the increase in the birefringence in the width direction. A difference of the birefringence in the width direction before the stretching step compensates the difference of the increase in the birefringence in the width direction after the stretching step. The evaporating section evaporates the water of the film released from the holding members.

The water content profile providing section preferably includes a damp air supplying section for applying damp air whose humidity is at least 60%RH and at most 100%RH to the film at a volume gradually decreasing from the side edge portions toward the center portion in the width direction. In addition, the water content profile providing section preferably includes a wetting section for bringing a whole film into contact with the water and a center portion water evaporating section for evaporating the water of the center portion after bringing the whole film into contact with the water.

According to the stretching method and stretching device of the present invention, the film is firstly provided with the water content profile in which the water content decreases from the side edge portions toward the center portion in the width direction, and then the film is stretched in the width direction while the side edge portions are being held. Owing to this, the film can be provided with even in-plane retardation Re in the width direction. According to the solution casting method of the present invention, the film with even in-plane retardation Re in the width direction can be effectively produced.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is an explanatory view illustrating an off-line stretching device;

FIG. 2 is a plan view illustrating a configuration of a first tenter;

FIG. 3 is a schematic side elevational view illustrating a process of wetting side edge portions of a film;

FIG. 4 is a plan view illustrating a configuration of a second tenter;

FIG. 5 is a schematic side elevational view illustrating a process of wetting a whole area of the film;

FIG. 6 is a schematic side elevational view illustrating a process of evaporating water in a center portion of the film;

FIG. 7 is an explanatory view illustrating a constant-rate drying period and a falling-rate drying period; and

FIG. 8 is an explanatory view illustrating a solution casting apparatus.

### DESCRIPTION OF THE PREFERRED EMBODIMENTS

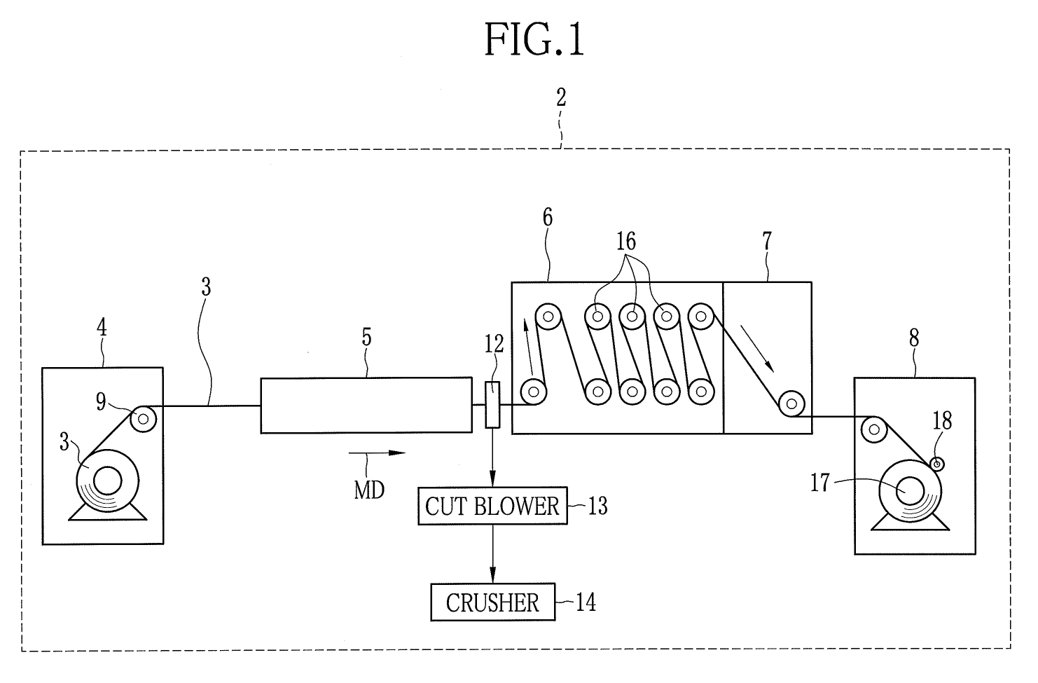

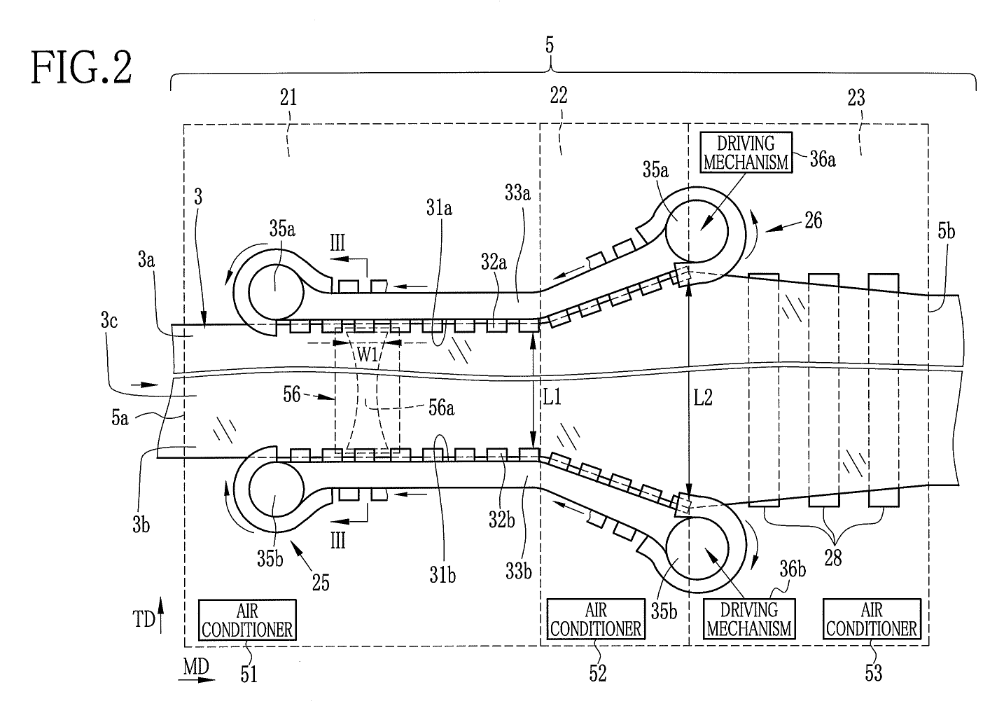

As shown in FIG. 1, an off-line stretching device 2 is used for stretching a long TAC film 3, and includes a film supply chamber 4, a tenter section 5, a relaxation chamber 6, a cooling chamber 7, and a winding chamber 8. The TAC film 3 that has been produced in a solution casting apparatus and wound in a roll form is loaded in the film supply chamber 4. The TAC film 3 is fed to the tenter section 5 by a supply roller 9. In the tenter section 5, a stretching process is performed to the TAC film 3. In the stretching process, both side edge portions 3a and 3b of the TAC film 3 are held with clips or the like and stretched in a width direction (see FIG. 2).

After being stretched in the tenter section 5, the TAC film 3 is sent to an edge slitting section 12. In the edge slitting section 12, the side edges, which were held with clips, are slit. The slit edges are cut into pieces by a cut blower 13. The side edges thus cut into pieces are sent to a crusher 14 by a not-shown blowing device and crushed into chips by the crusher 14. The chips are reused for preparing the dope, thus resulting in improvement in cost.

The relaxation chamber 6 includes plural rollers 16, and the TAC film 3 is transported by the rollers 16 in the relaxation chamber 6. Air at a desired temperature is blown to the relaxation chamber 6 by a blower (not-shown) to subject the TAC film 3 to heat treatment for stress relaxation. The temperature of the air is preferably in the range of 20° C. to 250° C. After this heat treatment in the relaxation chamber 6, the TAC film 3 is sent to the cooling chamber 7.

In the cooling chamber 7, the TAC film 3 is cooled to be 30° C. or less, and then sent to the wining chamber 8. The winding chamber 8 includes a winding roller 17 and a press roller 18. The TAC film 3 sent to the winding chamber 8 is wound by the winding roller 17 while being pressed by the press roller 18.

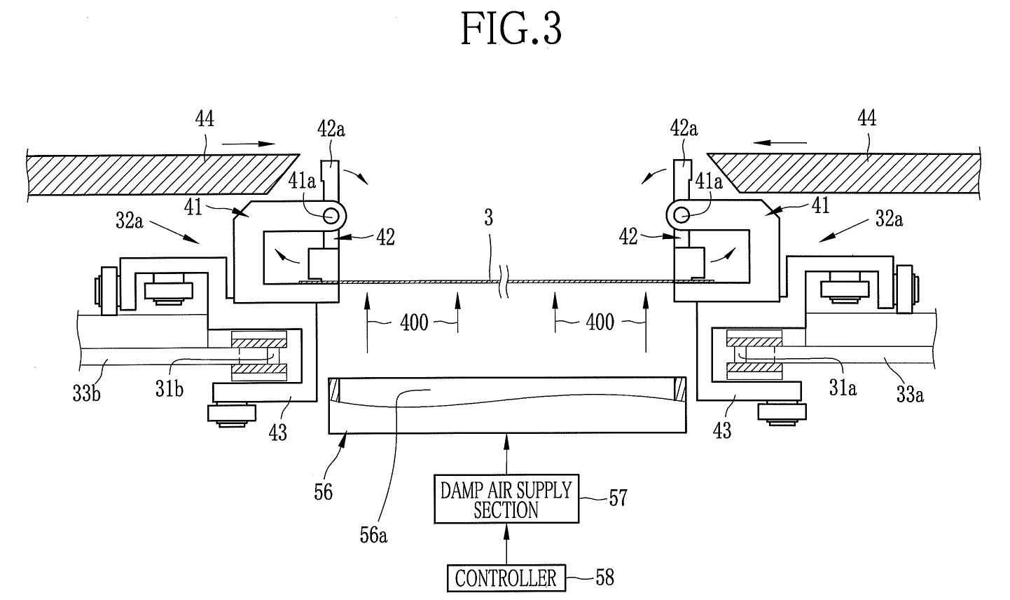

Next, the configuration of the tenter section 5 is explained. As shown in FIGS. 2 and 3, the tenter section 5 has first to third zones 21 to 23 whose drying conditions differ from each other.

In the tenter section 5, the first zone 21 is positioned in the most upstream side, and the second zone 22 follows the first zone 21 in the transfer direction of the TAC film 3, and then the third zone 23 is positioned next to the second zone 22. The first zone 21 is provided with an entrance 5a to which the TAC film 3 sent from the film supply chamber 4 enters, a hold position 25 at which the holding of the side edge portions 3a and 3b of the TAC film 3 initiates, and guide rollers (not shown) for guiding the TAC film 3 from the entrance 5a to the hold position 25. At the boundary of the second zone 22 and the third zone 23 is provided a release position 26 at which the side edge portions 3a and 3b of the TAC film 3 are released. The third zone 23 is provided with transfer rollers 28 for transferring the TAC film 3 that has passed through the release position 26 to downstream in the transfer direction, and an exit 5b from which the TAC film 3 is sent out to the edge slitting device 12. Note that the side edge portions 3a and 3b are defined as areas within 200 mm in the width direction from side ends of the TAC film 3.

The tenter section 5 is provided with a pair of chains 31a, 31b running through the first zone 21 to the third zone 23, clips 32a, 32b provided to the chains 31a, 31b at predetermined intervals, guide rails 33a, 33b for guiding the running chains 31a, 31b, chain sprockets 35a, 35b on which the chains 31a, 31b are wound, and driving mechanisms 36a, 36b for driving the chain sprockets 35a, 35b.

As shown in FIG. 3, each clip 32a is constituted of a substantially inverse C-shaped frame 41, a flapper 42, and a rail attachment portion 43. The flapper 42 is rotatably mounted to the frame 41 by an attachment shaft 41a. The flapper 42 shifts between a film holding position and a film releasing position. In the film holding position, as shown in FIG. 3, the flapper 42 stands approximately vertically. In the film releasing position, a releasing member 44 contacts and pushes an engagement head 42a of the flapper 42, and thereby tilting the flapper 42 from the vertical position. That is, the flapper 42 swings around the attachment shaft 41a. The flapper 42 is generally in the holding position under its own weight. The rail attachment portion 43 is attached to the chain 31a. Each clip 32a is guided along the guide rail 33a without falling off of the chain 31a. Note that each clip 32b has a bilaterally symmetric configuration as the clip 32a. Thus, the clips 32a, 32b endlessly run through the first zone 21 to the third zone 23 under the control of the driving mechanisms 36a, 36b.

When the clips 32a, 32b pass the hold position 25, the releasing members 44 retract from the engagement heads 42a, and thereby putting the flappers 42 into the film holding position by their own weight. Owing to this, the clips 32a, 32b hold the side edge portions 3a, 3b of the TAC film 3. The TAC film 3 whose side edge portions 3a, 3b are being held is guided from the hold position 25 to the release position 26 along with the clips 32a, 32b. When the clips 32a, 32b pass the release position 26, the flappers 42 are put into the film releasing position by the releasing members 44. Owing to this, the clips 32a, 32b release the side edge portions 3a, 3b. The TAC film 3 whose side edge portions 3a, 3b were released from the holding is then guided to the third zone 23. The transfer rollers 28 transfer the TAC film 3 to the exit 5b.

When a distance between the pair of rails 33a, 33b is defined as a “rail distance”, the rail distance is approximately uniform in the first zone 21. In the second zone 22, the pair of rails 33a, 33b is disposed such that the rail distance gradually widened toward the downstream in the transfer direction. The TAC film 3 is stretched in the width direction at a desired stretching ratio Lx by adjusting the rail distance. Here, the stretching ratio Lx is obtained by a formula of L2/L1 where L1 is the width of the TAC film 3 at the boundary of the first zone 21 and the second zone 22, and L2 is the width of the TAC film 3 at the release position 26 (see FIG. 2).

The first to third zones 21 to 23 respectively have air conditioners 51 to 53 for independently controlling air conditions, for example the temperature and the moisture of the air in the first to third zones 21 to 23. Moreover, in each first to third zone 21 to 23, there is a circulator (not shown) for circulating the inner air to maintain the conditions of an atmosphere in each first to third zone 21 to 23 uniform.

In the first zone 21, a duct 56 disposed to face one surface of the TAC film 3, a damp air supply section 57 for supplying damp air 400 to the duct 56, and a controller 58 for controlling the condition such as the temperature and the humidity of the damp air 400 are provided. The duct 56 has an opening 56a that extends across the whole width of the TAC film 3, that is, from the side edge portion 3a to the side edge portion 3b. A width W1 of the opening 56a in a direction MD is formed to be gradually thinned from its edges toward its center. That is, the edges of the opening 56a facing the side edge portions 3a, 3b have large widths compared to the center thereof facing the center portion 3c. Under the control of the controller 58, the damp air supply section 57 supplies the damp air 400, through the duct 56, to the TAC film 3, and thus performing a damp air supply process.

Here, the center portion 3c is defined as the area between the side edge portions 3a, 3b in the TAC film 3. The direction MD is the transfer direction of the TAC film 3 and approximately perpendicular to a width direction TD. Note that the surface of the TAC film 3 contacting a support in the later-described solution casting method is defined as a support side surface and the surface opposite to the support side surface is defined as an air side surface. The duct 56 can be positioned on either side of these surfaces of the TAC film 3.

An in-plane retardation Re of the TAC film 3 before the stretching process is preferably at least −20 nm and at most 20 nm. A thickness retardation Rth of the same is preferably at least 100 nm and at most 300 nm. Here, the in-plane retardation Re is calculated by the following formula (1) and the thickness retardation Rth is calculated by the following formula (2):

Re=TH×(Nx−Ny) (1)

Rth=TH×{(Nx−Ny)/2−Nth} (2)

where “Nx” is a refractive index in the slow axis direction, and “Ny” is a refractive index in the direction approximately perpendicular to the slow axis direction, and “Nth” is a refractive index in the thickness direction.

The length of the TAC film 3 is preferably at least 100 m. The width of the TAC film 3 is preferably at least 600 mm, and more preferably at least 1400 mm and at most 2500 mm. Even if the width is more than 2500 mm, the present invention is effective. Moreover, even if the thickness is at least 40 μm and at most 120 μm, the present invention can be applied.

The content of remaining solvent in the TAC film 3 in the second zone 22 is preferably at least 0.1 wt. % and at most 10 wt. %. Here, the content of remaining solvent in the TAC film 3 is on a dry basis and calculated by the following formula: {(x−y)/y}×100 where “x” is a weight of the TAC film 3 at the time of sampling and “y” is a weight of the same after drying.

The stretching process of the TAC film 3 in the tenter section 5 is explained in detail. As shown in FIG. 2, the side edge portion 3a, 3b of the TAC film 3 are held with the clips 32a, 32b at the hold position 25. The TAC film 3 is then guided to the release position 26 along with the clips 32a, 32b. The side edge portions 3a, 3b of the TAC film 3 are released from the clips 32a, 32b at the release position 26. The TAC film 3 is then guided to the third zone 23. The transfer rollers 28 transfer the TAC film 3 to the exit 5b and to the edge slitting device 12. The air conditioners 51 to 53 control the atmosphere of the first to third zones 21 to 23 to be the predetermined conditions, respectively.

The TAC film 3 whose side edge portions 3a, 3b are held with the clips 32a, 32b passes through the first zone 21 while maintaining the width of L1. The TAC film 3 then passes through the second zone 22 while the width is gradually widened from L1 to L2. Since the side edge portions 3a, 3b are released from the clips 32a, 32b at the release position 26, the TAC film 3 passes through the third zone 23 while naturally contracting its width.

In the first zone 21, the damp air supply section 57 supplies the damp air 400, through the duct 56, to the TAC film 3, and thus performing the damp air supply process. The damp air 400 whose amount corresponds to the width W1 is applied to the TAC film 3. Thereby the TAC film 3 is provided with water whose amount corresponds to the amount of the damp air 400 applied. Since the width W1 of the opening 56a of the duct 56 is formed to be thinned from the edges, facing the side edge portions 3a, 3b, toward the center thereof, facing the center portion 3c, the amount of the damp air 400 applied to the TAC film 3 decreases from the side edge portions 3a, 3b toward the center portion 3c. Accordingly, the TAC film 3 is provided with a water content profile in which the water content decreases from the side edge portions 3a, 3b toward the center portion 3c.

The water here includes the water contained in the TAC film 3 and the water attached to the TAC film 3. Percentage of water content is obtained by the formula: y1/x1×100 where x1 is a weight of a sample film and y1 is water content of the sample film. The water content y1 of the sample film can be measured using a moisture meter and a water vaporizer (CA-03, VA-05, both manufactured by Mitsubishi Chemical Corporation) according to the Karl Fischer's method.

In the second zone 22, the stretching process for stretching the TAC film 3 in the width direction TD while holding the side edge portions 3a, 3b is performed. Since the side edge portions 3a, 3b are held with the clips 32a, 32b during the stretching process, the side edge portions 3a, 3b have lower stretching property (flexibility) than the center portion 3c. Therefore, the polymer molecules orientation is less likely to occur in the side edge portions 3a, 3b. This stretching property of the TAC film 3, in other words, the poor flexibility of the side edge portions 3a, 3b, causes a difference of the increase in the birefringence in the width direction after the stretching process. After the stretching process, the birefringence increases such that an increase in the birefringence becomes larger from the side edge portions toward the center portion. The TAC film 3 to be fed to the stretching process has the water content profile in which the water content decreases from the side edge portions toward the center portion. Owing to this, the glass transition temperature of the polymer at the side edge portions 3a, 3b is lowered as compared to the center portion 3c, and therefore the polymer molecules orientation is more likely to occur in the side edge portions 3a, 3b. This water content profile causes the TAC film 3 to have a birefringence profile in which the birefringence decreases from the side edge portions toward the center portion in the width direction.

In the present invention, the TAC film 3 stretched in the width direction TD has the above-described water content profile. This water content profile causes the TAC film 3 to have the birefringence profile in which there is a difference of the birefringence in the width direction before the stretching process. This difference of the birefringence in the width direction compensates the difference of the increase in the birefringence in the width direction after the stretching process. As a result, unevenness of the in-plane retardation Re in the width direction is controlled and the in-plane retardation Re of the TAC film 3 is adjusted.

In the third zone 23, the air conditioner 53 heats the TAC film 3 being transported. Owing to this heating, an evaporation process for evaporating the water of the TAC film 3 is performed. At the exit 5b of the tenter section 5, the water content of the TAC film 3 is preferably at least 0.4 wt. % and at most 2 wt. %.

In the second zone 22, a difference in the water content (percentage) between each side edge portion 3a, 3b and the center portion 3c is preferably at least 1 wt. % and at most 5 wt. %. When the difference is less than 1 wt. %, the in-plane retardation Re is not sufficiently increased. When the difference is more than 5 wt. %, the in-plane retardation Re excessively increases. Therefore, the both cases are not preferable. In addition, the water content of each side edge portion 3a, 3b and the water content of the center portion 3c are preferably at least 2 wt. % and at most 10 wt. %, respectively in the second zone 22. When the water content of each is less than 2 wt. %, the glass transition temperature of the polymer is not sufficiently lowered. When the water content of each is more than 10 wt. %, the strength of the TAC film 3 decreases and the TAC film 3 is not uniformly stretched. Therefore, the both cases are not preferable. To provide the TAC film 3 with even in-plane retardation Re in the width direction, the water content profile in the width direction TD of the TAC film 3 can be determined according to the stretching conditions, such as the stretching ratio, stretching speed, temperature and the like, during the stretching process. The water content profile in the width direction TD is designed by changing the shape of the opening 56a, especially the variation of the width W1 in the width direction TD.

The humidity of the damp air 400 is preferably at least 60%RH and at most 100%RH. When the humidity is less than 60%RH, there is no effect in increasing the water content of the TAC film 3.

The content of remaining solvent of the TAC film 3 to which the damp air 400 is applied is preferably at least 0.1 wt. % and at most 10 wt. %, and more preferably at least 0.1 wt. % and at most 1 wt. %. When the content of remaining solvent of the TAC film 3 being subjected to the damp air 400 application is less than 0.1 wt. %, the drying device needs to be enlarged, which is not preferable. When the content of remaining solvent of the same is more than 10 wt. %, the control of the water content of the TAC film 3 becomes complicated, which is also not preferable.

In the second zone 22, the temperature of the TAC film 3 is preferably at least 50° C. and at most 150° C. When the temperature is lower than 50° C., the polymer molecules orientation is less likely to occur by the stretching, which is not preferable. When the temperature is higher than 150° C., additives (TPP, retardation control agent and the like) contained in the TAC film 3 maybe vaporized, which is not preferable. To maintain the water content profile (water content difference in the width direction TD) of the TAC film 3, the humidity of the atmosphere in the second zone 22 is preferably at least 60%RH and at most 100%RH.

The content of remaining solvent of the TAC film 3 in the second zone 22 is preferably at least 0.1 wt. % and at most 10 wt. %, and more preferably at least 0.1 wt. % and at most 1 wt. %. When the value is less than 0.1 wt. %, the drying device needs to be enlarged, which is not preferable.

The stretching ratio Lx is preferably at least 20% and at most 70%, and more preferably at least 30% and at most 60%. When the stretching ratio Lx is less than 20%, the in-plane retardation Re is not sufficiently increased, which is not preferable. When the stretching ratio Lx is more than 70%, the TAC film 3 may be torn, which is not preferable.

In the third zone 23, the temperature of the TAC film 3 is preferably at least 100° C. and at most 150° C. When the temperature is lower than 100° C., the water is not sufficiently evaporated, which is not preferable. When the temperature is higher than 150° C., the polymer molecules tend to be oriented again and the profile of the in-plane retardation Re provided to the TAC film 3 by the stretching process may be deformed, resulting optical unevenness, which is not preferable.

In the above embodiment, the difference of the increase in the birefringence in the width direction, which is caused by the poor flexibility of the side edge portions, is compensated by the difference of the birefringence in the width direction, which is caused by the water content profile. However, the present invention is not limited to this. For example, the water content profile can be adjusted in consideration of an increase in thickness of the TAC film 3 after the stretching process. The difference of the increase in the birefringence in the width direction can be compensated only by a difference of the birefringence in the width direction caused by the increase in the film thickness, or compensated by a combination of the difference of the birefringence in the width direction caused by the increase in the film thickness and the same caused by the water content profile.

Note that another duct may be provided opposite to the duct 56 across the TAC film 3 so that the damp air 400 is applied to both surfaces of the TAC film 3.

Although the damp air supply process is performed by applying the damp air 400 to the side edge portions 3a, 3b in the above embodiment, the present invention is not limited to this. For example, water may be coated on the side edge portions 3a, 3b, flown thereon or delivered by drops thereon. It is also possible to provide a partition plate between the areas where the side edge portions 3a, 3b pass and the area where the center portion 3c passes in the first zone 21 and control the atmosphere of the areas where the side edge portions 3a, 3b pass to be at least 60%RH and at most 100%RH.

Although the damp air supply process is performed using the damp air 400 in the above embodiment, the present invention is not limited to this. The areas held with the clips 32a, 32b and their periphery may be brought into contact with water. Specifically, the clips 32a, 32b may be provided with nozzles for supplying water to the side edge portions 3a, 3b. It is also possible that each flapper 42 is provided with a water containing member like a cloth or a sponge at its end and the water containing member is supplied with water by a water supplier while moving between the hold position 25 and the release position 26. For this configuration, the water content of the areas held with the clips and their periphery can be increased.

In the present invention, the water may be purified water or a mixture including water. When using the mixture, the water content in the mixture should be at least 60 wt. %. Besides the water, organic solvent, plasticizer, surface-active agent may be included as compounds in the mixture. Water soluble organic solvent having 1 to 10 carbon atoms is a preferable example of the organic solvent used. The water content in the mixture is preferably at least 90 wt. %, and more preferably at least 95 wt. %. Above all, the purified water is most preferably used.

In the above embodiment, the damp air supply process is performed only in the first zone 21, however the present invention is not limited to this. The damp air supply process may be performed in the second zone 22, that is, during the stretching process. Moreover, the damp air supply process may be performed before the TAC film 3 is fed to the tenter section 5.

In the above embodiment, the tenter section 5 was provided with three zones with different drying conditions, however the present invention is not limited to this. The tenter section 5 may be provided with four or more zones.

In the above embodiment, the duct 56 has the opening 56a whose width W1 decreases from the side edge portions 3a, 3b toward the center portion 3c, however the present invention is not limited to this. The damp air 400 may be applied only to the side edge portions 3a, 3b using a duct having openings facing only to the side edge portions 3a, 3b.

Next, the configuration of a tenter section 105 according to a second embodiment of the present invention is explained. Elements similar to those of the above embodiment are designated with identical reference numerals and the explanations thereof are omitted.

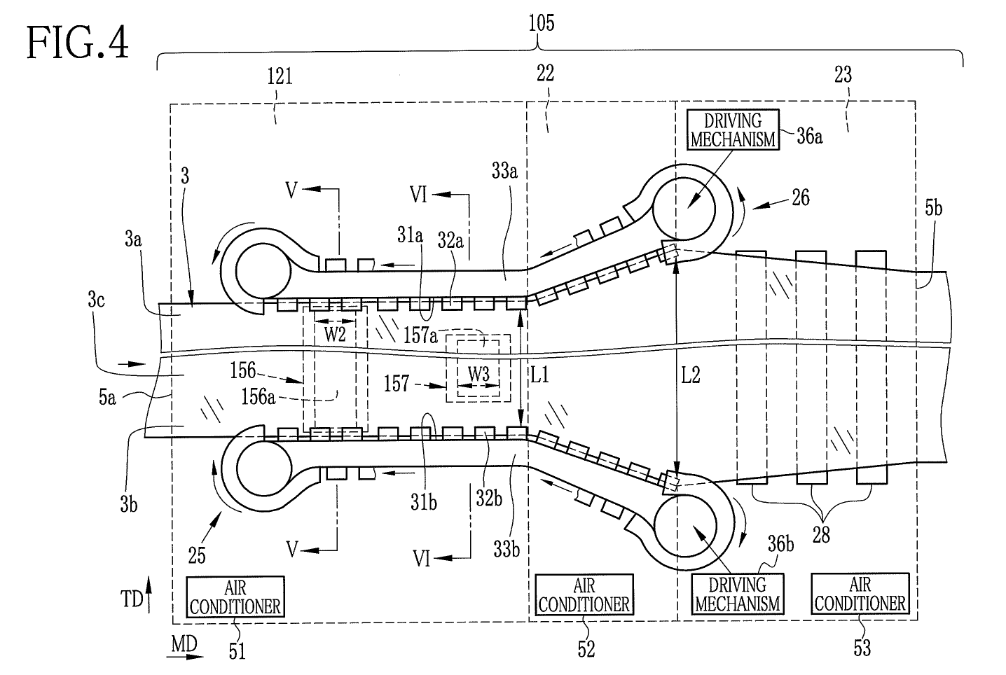

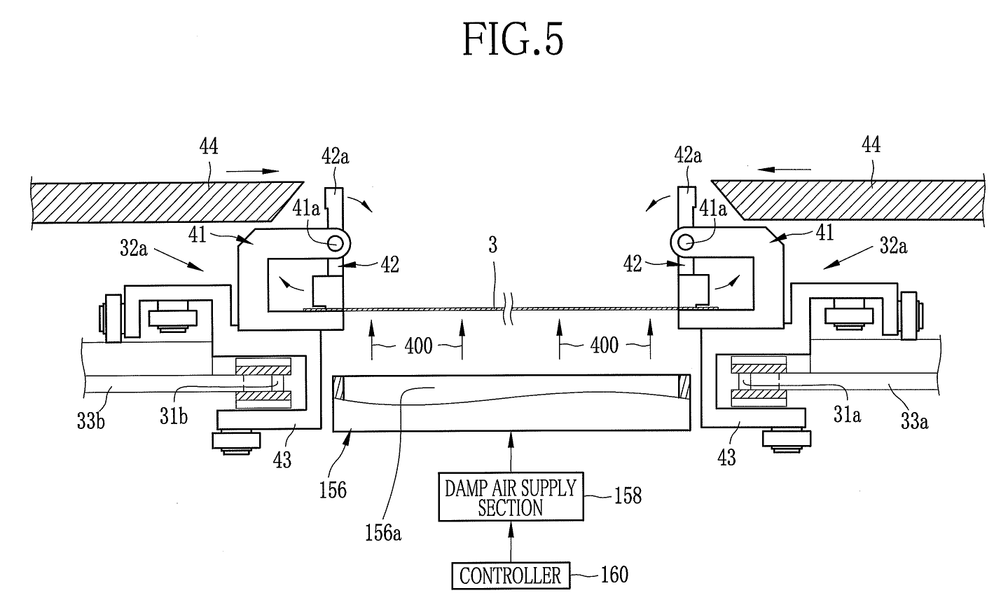

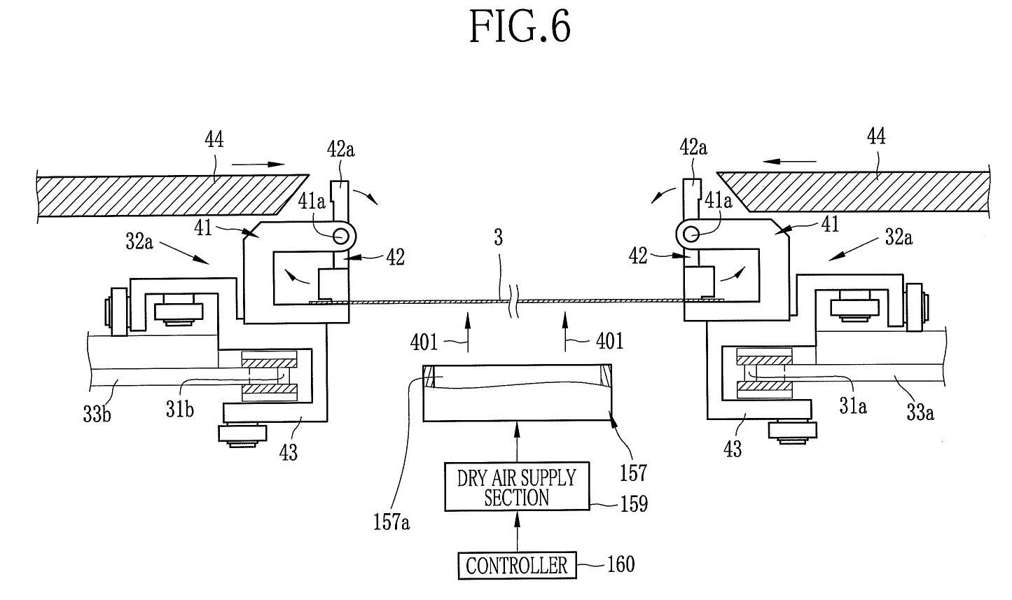

As shown in FIGS. 4 to 6, the tenter section 105 has a first zone 121, the second zone 22, and the third zone 23. The first zone 121 is provided with ducts 156, 157, a damp air supply section 158, a dry air supply section 159, and a controller 160. The duct 156 is positioned to face one surface of the TAC film 3. The duct 157 is positioned, downstream from the duct 156 in the direction MD, to face the one surface of the TAC film 3.

The duct 156 has an opening 156a that extends across the whole width of the TAC film 3, that is, from the side edge portion 3a to the side edge portion 3b. Meanwhile, the duct 157 has an opening 157a only facing the center portion 3c. A width W2 of the opening 156a and a width W3 of the opening 157a are formed to be approximately equal along the direction TD.

The damp air supply section 158 supplies the damp air 400 to the duct 156. The dry air supply section 159 supplies dry air 401 to the duct 157. The condition, such as the temperature and the humidity, of the damp air 400 and the condition of the dry air 401 are independently controlled by the controller 160.

Under the control of the controller 160, the damp air supply section 158 supplies the damp air 400 to a whole area, that is, the side edge portions 3a, 3b and the center portion 3c of the TAC film 3, and thereby performing a wetting process. Under the control of the controller 160, the dry air supply section 159 supplies the dry air 401 to the center portion 3c, to which the damp air 400 was applied, and thereby performing a center portion water evaporating process. Owing to the wetting process and the center portion water evaporating process, the TAC film 3 is provided with the water content profile in which the water content decreases from the side edge portions 3a, 3b toward the center portion 3c.

Next, the wetting process and the center portion water evaporating process in the first zone 121 are explained. In the first zone 121, the holding of the side edge portions 3a and 3b of the TAC film 3 with the clips 32a, 32b initiates at the hold position 25, and the TAC film 3 is transferred in the direction MD.

Under the control of the controller 160, the damp air supply section 158 supplies the damp air 400, through the duct 156, to the side edge portions 3a, 3b and the center portion 3c of the TAC film 3 approximately evenly, and thereby performing the wetting process. Owing to this wetting process, the water content of the TAC film 3 increases uniformly in the width direction TD. Then, under the control of the controller 160, the dry air supply section 159 supplies the dry air 401, through the duct 157, to the center portion 3c of the TAC film 3, and thereby performing the center portion water evaporating process. Owing to the wetting process and the center portion water evaporating process, the TAC film 3 is provided with the water content profile in which the water content decreases from the side edge portions toward the center portion. Accordingly, the TAC film 3 can be provided with approximately even in-plane retardation Re in the width direction TD after the stretching process in the second zone 22.

In the center portion water evaporating process, the TAC film 3 is preferably in a falling-rate drying period. If the TAC film 3 is in the falling-rate drying period and has water contained therein and attached thereto, network structure of the polymer molecules is expanded by water molecules by drying the center portion 3c. Owing to this, solvent compounds residing far from the surfaces of the TAC film 3 can easily reach the periphery of the surfaces. As a result, the solvent remaining in the center portion 3c can be easily evaporated along with the water. The TAC film 3 after the center portion water evaporating process has a solvent profile in which the content of the remaining solvent decreases from the side edge portions 3a, 3b toward the center portion 3c. In the stretching process, the polymer molecules orientation is less likely to occur where the content of the remaining solvent is small and the polymer molecules orientation is more likely to occur where the content of the remaining solvent is large. This solvent profile in the stretching process causes a difference of the increase in the birefringence in the width direction. That is, the birefringence of the TAC film 3 increases such that the increase in the birefringence becomes larger from the side edge portions toward the center portion after the stretching process.

In the present invention, the TAC film 3 having the predetermined water content profile and the predetermined solvent profile is stretched in the width direction TD while the side edge portions 3a, 3b are being held. Owing to this, the difference of the increase in the birefringence in the width direction caused by the poor flexibility of the side edge portions 3a, 3b during the stretching process can be compensated by the difference of the birefringence in the width direction due to the water content profile and the difference of the birefringence in the width direction due to the solvent profile. As a result, unevenness of the in-plane retardation Re in the width direction is controlled and the in-plane retardation Re of the TAC film 3 is adjusted.

Next, a constant-rate drying period and the falling-rate drying period in the present invention are explained. In the earlier stage of the drying process, the TAC film 3 contains a volume of solvent, so the main process here is to release the solvent and the like residing near the surfaces to outside. Such period is defined as the constant-rate drying period. In the middle to final stage of the drying process, the main process is that the solvent and the like residing in the TAC film 3 are once dispersed to the periphery of the surfaces, and then released outside. Such period is defined as the falling-rate drying period.

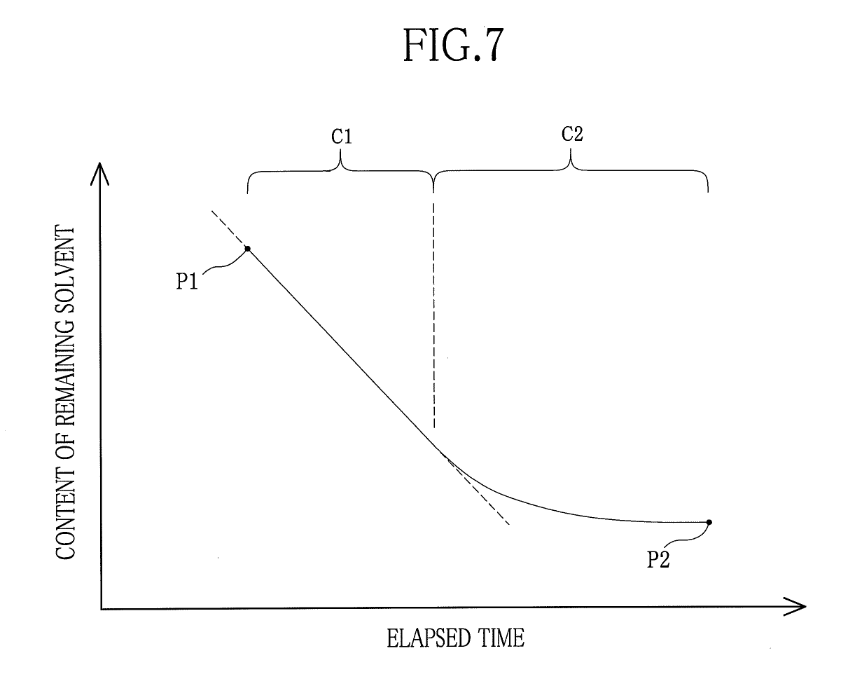

FIG. 7 is a distribution chart indicating a variation in the remaining solvent content versus time for performing the drying process at uniform drying conditions (elapsed time). In the drying process with uniform drying conditions, a period where a gradient of the remaining solvent content becomes approximately uniform may be defined as a constant-rate drying period C1 and a period after the constant-rate drying period C1 may be defined as a falling-rate drying period C2. In FIG. 7, P1 shows the relation between the remaining solvent content in a casting film 233 right after being formed on the support in the later-described solution casting method and the corresponding elapsed time, and P2 shows the relation between the remaining solvent content in the TAC film 3 in the first zone 121 and the corresponding elapsed time. The falling-rate drying period C2 may be defined without using such distribution chart. For example, a period where the content of the remaining solvent is at most 10 wt. %, and more preferably at most 1 wt. % may be defined as the falling-rate drying period C2.

In the above embodiment, the damp air 400 is applied to the whole area of the TAC film 3 in the wetting process, however the present invention is not limited to this. The water may be coated on the whole area of the TAC film 3, flown thereon or delivered by drops thereon. It is also possible to provide a partition plate between the ducts 156 and 157 and control the atmosphere of the area where the TAC film 3 passes to be at least 60%RH and at most 100%RH. The whole area of the TAC film 3 may also be soaked into the water.

In the above embodiment, the dry air 401 is applied only to the center portion 3c, and thereby performing the center portion water evaporating process. However, it is also possible to apply the dry air 401 to the whole area of the TAC film 3 using a duct with an opening whose edges, facing the side edge portions 3a, 3b, having small widths and center portion, facing the center portion 3c, having large width.

In the above embodiment, the wetting process and the center portion water evaporating process are performed in the first zone 121, however the present invention is not limited to this. The center portion water evaporating process may be performed in the second zone 22, that is, during the stretching process, or before the TAC film 3 is fed to the tenter section 5. The wetting process may be performed before the TAC film 3 is fed to the tenter section 5 or in the second zone 22 as long as it is performed before the center portion water evaporating process.

In the above embodiment, the damp air supply process is performed using single duct, however the present invention is not limited to this. For example, plural ducts may be arranged along the width direction TD. At this time, a damp air supply device that controls the amount of the damp air 400 sent to each duct independently is used. With use of such damp air supply device, the damp air supply process is performed while controlling the amount of damp air 400 fed to the TAC film 3 to be decreased from the side edge portions 3a, 3b toward the center portion 3c. When single duct is used, the duct may have single opening or plural openings. When having plural openings, the dimension of the opening may be decreased from the side edge portions toward the center portion.

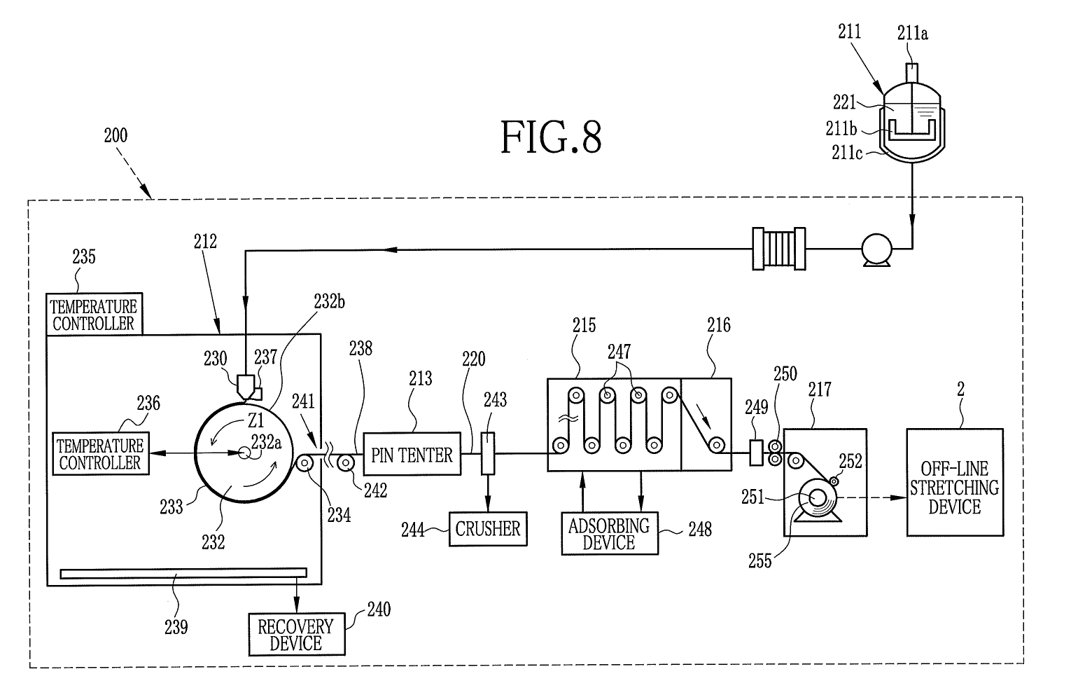

In FIG. 8, a solution casting apparatus 200 is illustrated. The solution casting apparatus 200 includes a stock tank 211, a casting chamber 212, a pin tenter 213, a drying chamber 215, a cooling chamber 216, a winding chamber 217, and the off-line stretching device 2.

The stock tank 211 is provided with a motor 211a, a stirrer 211b to be rotated by the drive of the motor 211a, and a jacket 211c. The stock tank 211 contains a dope 221 in which a polymer as a raw material of the TAC film 3 is dissolved in a solvent. The temperature of the dope 221 in the stock tank 211 is maintained approximately constant by the jacket 211c. Owing to the rotation of the stirrer 211b, the polymer and the like are prevented from agglomerated, and thereby keeping the quality of the dope 221 uniform.

The casting chamber 212 is provided with a casting die 230, a casting drum 232 as the casting support, a peel roller 234, temperature controllers 235, 236, and a decompression chamber 237. The casting drum 232 rotates around a shaft 232a in a direction Z1 by the drive of a drying mechanism (not shown). The temperature controllers 235, 236 set the temperature inside the casting chamber 212 and the temperature of the casting drum 232 to the values facilitating gelation of the casting film 233.

The casting die 230 casts the dope 221 onto a peripheral surface 232b of the casting drum 232 rotating. Thus, the casting film 233 is formed from the dope 221 on the peripheral surface 232b of the casting drum 232. While the casting drum 232 makes about ¾ rotation, the casting film 233 exerts a self-supporting property by the gelation. The casting film 233 with the self-supporting property is then peeled by the peel roller 234 from the casting drum 232 as a wet film 238. The content of remaining solvent in the casting film 233 at the time of the peeling is preferably at least 150 wt. % and at most 320 wt. %.

The decompression chamber 237 is disposed upstream from the casting die 230 in the direction Z1. Inside the decompression chamber 237 is set to a negative pressure. A rear side (the side contacting the peripheral surface 232b later) of a casting bead is decompressed by the decompression chamber 237 at a desired value. Owing to this, the influence of air caused by the rotation of the casting drum 232 is reduced, and thereby stabilizing the shape of the casting bead. Thus, the casting film 233 with less unevenness in thickness can be formed.

The material of the casting die 230 should have high corrosion resistance in a mixture liquid of electrolyte solution, dichloromethane and methanol and low coefficient of thermal expansion. The finish accuracy of the contact surface of the casting die 230 to the dope 221 is at most 1 min surface roughness and at most 1 μm/m in straightness in any direction.

Chrome plating is preferably performed to the peripheral surface 232b of the casting drum 232 such that the drum 232 has enough resistance of corrosion and strength. To maintain the temperature of the peripheral surface 232b at a desired value, a heat transfer medium is circulated by the temperature controller 236. Owing to the circulation of the transfer medium through a path provided in the casting drum 232, the temperature of the peripheral surface 232b is maintained at the desired value.

The width of the casting drum 232 is not restricted especially. However, the width is preferably 1.1 times to 2.0 times as large as the casting width of the dope. The casting drum 232 is preferably made of stainless steel, and especially of SUS 316 so as to have enough resistance of corrosion and strength. The chrome plating performed to the peripheral surface 323b of the casting drum 232 is preferably so-called hard chrome plating with Vickers hardness value of at least Hv700 and a thickness of at least 2 μm.

The casting chamber 212 is provided with a condenser 239 and a recovery device 240. The condenser 239 condenses and liquefies solvent gas evaporated. The recovery device 240 recovers the liquefied solvent. There covered solvent is refined by a refining device as the solvent to be reused for preparing the dope.

A transfer section 241 is disposed downstream from the casting chamber 212 and followed by the pin tenter 213. The transfer section 241 is provided with a number of rollers 242. The wet film 238 is fed to the pin tenter 213 by the rollers 242. The pin tenter 213 has pin plate whose pins pierce the side edge portions of the wet film 238. The pin plate runs on the rail. Dry air is applied to the wet film 238 running along with the pin plate, and thereby the wet film 238 is dried to be the film 220.

The pin tenter 213 is provided with clips for holding the side edge portions of the film 220. The clips run on the rail. Dry air is applied to the film 220 running along with the clips, and thereby the film 220 is dried while being stretched in the width direction.

An edge slitting device 243 is disposed downstream from the pin tenter 213. The edge slitting device 243 slits the side edge portions of the film 220. The slit edges are sent to a crusher 244 by a blowing device (not shown) and crushed into chips by the crusher 244. The chips are reused for preparing the dope.

The drying chamber 215 is provided with plural rollers 247. In the drying chamber 215, the film 220 is bridged across the rollers 247 and transported. On the exit side of the drying chamber 215 is disposed the cooling chamber 216. The film 220 is cooled down to approximately the room temperature in the cooling chamber 216. A neutralization device (neutralization bar) 249 is disposed downstream from the cooling chamber 216. The film 220 is neutralized in the neutralization device 249. A knurling roller pair 250 is disposed downstream from the neutralization device 249. The knurling roller pair 250 forms knurling on both side edges of the film 220. In the winding chamber 217, a winding roller 251 and a press roller 252 are provided. The film 220 is wound up by the winding roller 251 while the press roller 252 controls tension thereof. Thus, a film roll 255 wound around a roll core is obtained.

The film roll 255 is sent from the winding chamber 217 to the film supply chamber 4 of the off-line stretching device 2 (see FIG. 1), and fed from the film supply chamber 4 as the TAC film 3.

In the above embodiments, the stretching process is performed in the off-line stretching device 2. However, the present invention is not limited to this. The stretching process similar to the one performed in the off-line stretching device 2 may be performed between the pin tenter 213 and the drying chamber 215 of the solution casting apparatus 200.

In the above embodiments, the TAC films 3 and 103 are the examples of the polymer film. The present invention is applicable not only for the TAC films 3 and 103, but also for various kinds of polymer films.

In the above embodiment, the casting drum 232 is used as the casting support. However, the casting support may be a different form other than the casting drum 232. For example, an endless belt that is turned about by two driving rollers may be the casting support.

In the above embodiment, the casting film 233 is cooled to possess the self-supporting property. However, the self-supporting property may be developed by drying the casting film 233.

In the above embodiment, the casting film is formed from a single dope. However, the present invention is not limited to this. In the solution casting of the present invention, the dopes, namely two or more sorts of dopes, can be cast according to simultaneous co-casting or sequential co-casting, or a combination of the both. When the simultaneous co-casting is performed, a feed block may be attached to the casting die, or a multi-manifold type casting die may be used. A thickness of at least one surface layer, which is exposed to outside, of a multi-layered membrane is preferably in the range of 0.5% to 30% to the total thickness of the film. Moreover, in the simultaneous co-casting method, it is preferable to preliminary adjust each dope's viscosity such that the lower viscosity dopes entirely cover over the higher viscosity dope when the dopes are cast onto the support from the die slit. Furthermore, in the simultaneous co-casting method, it is preferable that the inner dope is covered with dopes whose alcohol composition ratio is larger than that of the inner dope in the bead, which is formed between the die slit and the support.

[Polymer]

As polymer of this embodiment, the already known polymer to be used for the film production may be used. For example, cellulose acylate is preferable, and triacetyl cellulose (TAC) is especially preferable. It is preferable in cellulose acylate that the degree of substitution of acyl groups for hydrogen atoms on hydroxyl groups of cellulose preferably satisfies all of following formulae (I)-(III). In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.

2.5≦A+B≦3.0 (I)

0≦A≦3.0 (II)

0≦B≦2.9 (III)

Further, polymer to be used in the present invention is not restricted in cellulose acylate.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100 %, the degree of acylation is 1.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particylarly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7. According to DSB, the percentage of the substitution on the 6^{th} position to that on the 2^{nd}, 3^{rd} and 6^{th} positions is at least 20%. The percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability. Note that the dope contains a polymer and a solvent for dissolving the polymer. Further, if necessary, an additive is added to the dope.

The cellulose as the raw material of the cellulose acylate may be obtained from one of the pulp and the linter.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

[Solvent]

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent. It is to be noted in the present invention that the dope is a polymer solution or a dispersion that is obtained by dissolving or dispersing the polymer in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 wt. % to 25 wt. %, andparticularly in the range of 5 wt. % to 20 wt. %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 carbons, and alcohols having 1 to 12 carbons are preferable, and a mixture thereof can be used adequately. For example, there is a mixture of methyl acetate, acetone, ethanol and n-butanol. These ethers, ketones, esters and alcohols may have the ring structure. Further, the compounds having at least two of functional groups in ethers, ketones, esters and alcohols (namely, —O—, —CO—, —COO— and —OH) can be used for the solvent.

Note that the detailed explanation of cellulose acylate is made from [0140] to [0195] in Japanese Patent Laid-Open Publication No. 2005-104148, and the description of this publication can be applied to the present invention. Note that the detailed explanation of the solvents and the additive materials of the additive (such as plasticizers, deterioration inhibitors, UV-absorptive agents, optical anisotropy controllers, dynes, matting agent, release agent, retardation controller and the like) is made from [0196] to [0516] in Japanese Patent Laid-Open Publication No. 2005-104148.

### EXAMPLE 1

The TAC film 3 with the width of 2000 mm and the thickness TH of 65 μm was sent to the tenter section 5 of the off-line stretching device 2 shown in FIG. 1. In the first zone 21, the damp air 400 with the temperature of 85° C. and the humidity of 85%RH was applied to the side edge portions 3a, 3b of the TAC film 3, and thereby the TAC film 3 was provided with the water content profile in which the water content WYc at the center portion 3c was 5 wt. % and the water content WYe at each side edge portion 3a, 3b was 7 wt. %. In the second zone 22, the atmosphere was adjusted to have the temperature T2 of approximately 120° C. and the humidity of 80%RH, and the stretching process was performed to the TAC film 3 at the stretching ratio Lx of 1.45. In the third zone 23, the temperature of the TAC film 3 was controlled to be approximately uniform within the range of at least 100° C. and at least 150° C., and the evaporation process for evaporating the water content of the TAC film 3 was performed until the water content of the TAC film 3 reached to at least 0.4 wt. % and at most 2 wt. %.

### COMPARATIVE EXAMPLE 1

The stretching process was performed in the same manner as Example 1 except that the water content profile in which the water content WYc at the center portion 3c and the water content WYe at each side edge portion 3a, 3b were both made 5 wt/% by applying the damp air 400 to the TAC film 3 in the first zone 21.

### COMPARATIVE EXAMPLE 2

The stretching process was performed in the same manner as Example 1 except that the water content profile in which the water content WYc at the center portion 3c and the water content WYe at each side edge portion 3a, 3b were both made 1.4 wt/% without applying the damp air 400 to the TAC film 3 in the first zone 21, and the stretching ratio Lx during the stretching process was 1.20 in the second zone 22.

### COMPARATIVE EXAMPLE 3

The stretching process was performed in the same manner as Example 1 except that the water content profile in which the water content WYc at the center portion 3c and the water content WYe at each side edge portion 3a, 3b were both made 1.4 wt/% without applying the damp air 400 to the TAC film 3 in the first zone 21, and the temperature T2 of the atmosphere was 180° C. in the second zone 22.

1. Measurement of In-plane Retardation (Re)

Part of each TAC film subjected to the stretching process was cut in the width direction to be sampled. Nine measurement points were set on the sample along the width direction TD. The moisture of the sample at each measurement point was adjusted under a temperature of 25° C. and a humidity of 60%RH for 2 hours. Then, the in-plane retardation Re was measured at each measurement point using an automatic birefringence meter (KOBRA21DH, manufactured by Oji Scientific Instrument Col, Ltd.). The measurement of the retardation was made at a wavelength of 632.8 nm. Then, an average value Reav (nm) of the measured in-plane retardation Re was obtained.

2. Measurement of Haze

The haze was measured using a sample of each TAC film cut into the size of 40 mm×80 mm by a haze meter (HGM-2DP, manufactured by Suga test instruments Co., Ltd.) at a temperature of 25° C. and a humidity of 60%RH according to JIS K-6714.

3. Evaluation of In-plane Retardation (Re)

A width of area having approximately uniform in-plane retardation Re was evaluated using ReX. ReX is obtained by dividing the width W0 of the whole TAC film by the width W1 of the area whose value of the in-plane retardation Re satisfies the following formula:

|Re−Reₐᵥ|/Reₐᵥ≦0.07

4. Evaluation of Additive Vaporization

Vent holes of the air conditioners 51 to 53 in the tenter section 5 was checked whether there are additives adhered or not. The vaporization of the additives was evaluated according to the following criteria:

Good: The adhesion of additives was hardly observed.

Bad: The adhesion of additives was observed.

The conditions, measurement values, and evaluation results of Example 1 and Comparative Examples 1 to 3 are shown in Table 1. In Table 1, “WYc” is the water content at the center portion of the TAC film 3, “WYe” is the water content at each side edge portion of the TAC film 3, “T2” is the temperature of the atmosphere in the second zone 22, and “Lx” is the stretching ratio of the stretching processing. Numbers shown in a column of evaluation in Table 1 are same as those assigned to the evaluation categories.

TABLE 1

| | WYc | | | | Evaluation | | | |
|---|---|---|---|---|---|---|---|---|
| | (wt. | WYe | T2 | | 1 | 2 | 3 | |
| | %) | (wt. %) | (° C.) | Lx | (nm) | (%) | (%) | 4 |
| Ex. 1 | 5 | 7 | 120 | 1.45 | 60 | 0.5 | 85 | Good |
| Com. Ex. 1 | 5 | 5 | 120 | 1.45 | 60 | 0.5 | 75 | Good |
| Com. Ex. 2 | 1.4 | 1.4 | 120 | 1.20 | 35 | 1.3 | 75 | Good |
| Com. Ex. 3 | 1.4 | 1.4 | 180 | 1.45 | 55 | 0.8 | 75 | Bad |

According to the results of Example 1 and Comparative Examples 1 to 3, it is understood that the even in-plane retardation Re in the width direction TD is provided to the TAC film by stretching the side edge portions having higher water content than the center portion.

Various changes and modifications are possible in the present invention and may be understood to be within the present invention.

What is claimed is:

1. A stretching method for stretching a film containing a polymer and a solvent comprising the steps of:
providing said film with a water content profile in which water content decreases from side edge portions toward a center portion in a width direction by bringing said film into contact with water, said water content profile causing said film to have a birefringence profile in which a birefringence decreases from said side edge portions toward said center portion in said width direction;
stretching said film having said water content profile and said birefringence profile in said width direction while holding said side edge portions, said film having a stretching property decreasing as closer to said side edge portions, said birefringence increasing after said stretching step such that an increase in said birefringence becomes larger from said side edge portions toward said center portion, said stretching property causing a difference of said increase in said birefringence in said width direction, a difference of said birefringence in said width direction before the stretching step compensating said difference of said increase in said birefringence in said width direction after the stretching step; and
evaporating said water of said film after said stretching step.

2. The stretching method of claim 1, wherein said water content of each said side edge portion is at least 1 wt. % and at most 5 wt. % higher than said water content of said center portion.

3. The stretching method of claim 1, wherein said water content of each said side edge portion and said water content of said center portion are respectively at least 2 wt. % and at most 10 wt. %.

4. The stretching method of claim 1, wherein said water content profile providing step including the step of:
applying damp air whose humidity is at least 60%RH and at most 100%RH to said film at a volume gradually decreasing from said side edge portions toward said center portion in said width direction.

5. The stretching method of claim 1, wherein a content of remaining solvent in said film during said stretching step is at least 0.1 wt. % and at most 10 wt. %.

6. The stretching method of claim 1, wherein said water content profile providing step including the steps of:
bringing a whole of said film into contact with said water; and
evaporating said water of said center portion after bringing the whole of said film into contact with said water.

7. The stretching method of claim 6, wherein said film is in a falling-rate drying period while evaporating said water of said center portion.

8. The stretching method of claim 1, wherein a temperature of said film during the stretching step is at least 50° C. and at most 150° C.

9. A solution casting method comprising the steps of:
casting a dope containing a polymer and a solvent on a support continuously moving and forming a casting film on said support;
peeling said casting film, turned into gel by cooling, as a film;
providing said film with a water content profile in which water content decreases from side edge portions toward a center portion in a width direction by bringing said film into contact with water, said water content profile causing said film to have a birefringence profile in which a birefringence decreases from said side edge portions toward said center portion in said width direction;
stretching said film having said water content profile and said birefringence profile in said width direction while holding said side edge portions, said film having a stretching property decreasing as closer to said side edge portions, said birefringence increasing after said stretching step such that an increase in said birefringence becomes larger from said side edge portions toward said center portion, said stretching property causing a difference of said increase in said birefringence in said width direction, a difference of said birefringence in said width direction before the stretching step compensating said difference of said increase in said birefringence in said width direction after the stretching step; and
evaporating said water of said film after said stretching step.

10. A film stretching device comprising:
a water content profile providing section for providing said film with a water content profile in which water content decreases from side edge portions toward a center portion in a width direction by bringing said film into contact with water, said water content profile causing said film to have a birefringence profile in which a birefringence decreases from said side edge portions toward said center portion in said width direction;
a pair of holding members for holding said side edge portions of said film having said water content profile and said birefringence profile;
a stretching section for stretching said film in said width direction by guiding said holding members, said film having a stretching property decreasing as closer to said side edge portions, said birefringence increasing after said stretching step such that an increase in said birefringence becomes larger from said side edge portions toward said center portion, said stretching property causing a difference of said increase in said birefringence in said width direction, a difference of said birefringence in said width direction before the stretching step compensating said difference of said increase in said birefringence in said width direction after the stretching step; and
evaporating section for evaporating said water of said film released from said holding members.

11. The film stretching device of claim 10, wherein said water content profile providing section including:
a damp air supplying section for applying damp air whose humidity is at least 60%RH and at most 100%RH to said film at a volume gradually decreasing from said side edge portions toward said center portion in said width direction.

12. The film stretching device of claim 10, wherein said water content profile providing section including:
a wetting section for bringing a whole of said film into contact with said water; and
a center portion water evaporating section for evaporating said water of said center portion after bringing the whole of said film into contact with said water.
